(19) United States
(12) Patent Application Publication
(10) Pub. No.: US 2020/0194838 A1
(43) Pub. Date: Jun. 18, 2020

(54) LITHIUM SECONDARY BATTERY

(71) Applicants: Hyundai Motor Company, Seoul (KR); Kia Motors Corporation, Seoul (KR)

(72) Inventors: Yoon Ji LEE, Bucheon-si (KR); Seung Ho AHN, Hanam-si (KR); Yoon Sung LEE, Suwon-si (KR); Sang Joon LEE, Anyang-si (KR); Sa Heum KIM, Suwon-si (KR); Dong Hui KIM, Suwon-si (KR)

(73) Assignees: Hyundai Motor Company, Seoul (KR); Kia Motors Corporation, Seoul (KR)

(21) Appl. No.: 16/415,096

(22) Filed: May 17, 2019

(30) Foreign Application Priority Data
Dec. 13, 2018 (KR) 10-2018-0160629

(51) Int. Cl. H01M 10/0568; H01M 4/38; H01M 10/0525; C07F 5/02

(52) U.S. Cl. CPC H01M 10/0568; H01M 4/386; H01M 2004/027; C07F 5/022; H01M 10/0525

(57) ABSTRACT

A lithium secondary battery may include a cathode, an anode, a separator disposed between the cathode and anode and an electrolyte, wherein the anode includes a silicon-based material, and wherein the electrolyte comprises 1 to 10 wt % of LiDFOB based on the total weight of the electrolyte.

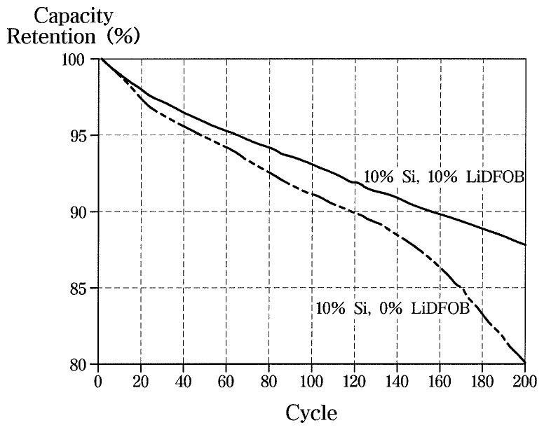

### CROSS-REFERENCE TO RELATED APPLICATION(S)

The present application claims priority to Korean Patent Application No. 10-2018-0160629, filed on Dec. 13, 2018, the entire contents of which is incorporated herein for all purposes by this reference.

### BACKGROUND OF THE INVENTION

### Field of the Invention

The present invention relates to a lithium secondary battery.

### Description of Related Art

In general, a lithium secondary battery including an electroactive material has a high operating voltage and high energy density compared to a lead battery or a nickel/cadmium battery. Accordingly, lithium secondary batteries have widely been used as energy storage means for Electric Vehicles (EVs) and Hybrid Electric Vehicles (HEVs).

The mileage of EVs may be improved by densifying battery energy. To densify battery energy, the energy density of materials used in batteries needs be improved. Recently, lithium secondary batteries using a Ni-, Co-, or Mn-based cathode and a graphite anode have been developed. However, other materials capable of replacing the materials are also being developed to overcome limitations of energy density. Therefore, there is a need to develop silicon having a large capacity exceeding 4000 mAh/g and high energy density compared to graphite having a capacity of 360 mAh/g.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a lithium secondary battery having improved durability characteristics by use of an electrolyte including lithium oxalydifluoroborate (LiDFOB).

Additional aspects of the disclosure will be set forth in part in the description which follows and, in part, will be obvious from the description, or may be learned by practice of the disclosure.

In accordance with an aspect of the present invention, a lithium secondary battery may include a cathode, an anode, a separator disposed between the cathode and anode, and an electrolyte; wherein the anode may include a silicon-based material, wherein the electrolyte may include 1 to 10 wt % of LiDFOB based on a total weight of the electrolyte.

The electrolyte may include 5 to 10 wt % of LiDFOB based on the total weight of the electrolyte.

The anode may include 5 to 30 wt % of the silicon-based material based on a total weight of the anode.

The anode may include 10 to 20 wt % of the silicon-based material based on the total weight of the anode.

### BRIEF DESCRIPTION OF THE DRAWINGS

FIGURE shows a cycle performance profile of an anode according to an exemplary embodiment of the included embodiment.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Like numbers refer to like elements throughout the present specification. This specification does not describe all components of the embodiments, and the general information in the field of the present invention to which the present invention belongs or the overlapping information between the exemplary embodiments will not be described.

Also, it will be understood that the terms “includes,” “comprises,” “including,” and/or “comprising” when used in the present specification, specify the presence of a stated component, but do not preclude the presence or addition of one or more other components.

It is to be understood that the singular forms “a,” “an,” and “the” include plural referents unless the context clearly dictates otherwise.

Hereinafter, embodiments of the present invention will be described in detail with reference to the accompanying drawings and tables.

Generally, a lithium secondary battery includes a cathode, an anode, a separator, and an electrolyte. The cathode, the anode, and the separator forming an electrode structure may be implemented using components commonly used to manufacture a lithium secondary battery.

An electrode may include an electrode active material and a binder according to the embodiment. The electrode according to the exemplary embodiment may be formed by applying an electrode slurry in which an electrode active material, a binder, a solvent, and a conductive material are mixed to an electrode current collector to a predetermined thickness, and then drying the electrode slurry and rolling the electrode.

An anode active material which is used to manufacture the anode may be provided using any anode active material allowing intercalation and deintercalation of lithium ions. The anode active material may include at least one selected from the group consisting of a material allowing reversible intercalation and deintercalation of lithium ions, a metal material forming an alloy with lithium, a mixture thereof, or a combination thereof.

The material allowing reversible intercalation and deintercalation of lithium ions may be at least one material selected from the group consisting of synthetic graphite, natural graphite, graphitized carbon fiber, graphitized mesocarbon microbeads (MCMB), fullerene, and amorphous carbon.

The amorphous carbon may be hard carbon, coke, MCMB, and mesophase pitch-based carbon fiber (MPCF) sintered at the temperature of 1500° C. or lower, or the like.

Also, the metal material configured for forming an alloy with lithium may be at least one metal selected from the group consisting of Al, Si, Sn, Pb, Zn, Bi, In, Mg, Ga, Cd, Ni, Ti, Mn, and Ge. The metal materials may be used alone, in combination, or in an alloy. Also, the metal may be used as a composite mixed with a carbon-based material.

According to various aspects of the present invention, the anode active material may include a composite of a graphite-based anode active material and a silicon (Si)-based anode active material. As demands for high energy lithium secondary batteries have increased, attempts have been made to use a silicon-based anode active material having a high specific capacity to increase the current density of the electrode. However, the silicon-based anode active material has a high capacity, but excessively expands as charging/discharging (lithium intercalation and deintercalation) progresses, causing breakage of the active material and desorption from the current collector. In particular, due to continued volume the continued volume expansion, the silicon-based anode active material having a high content is disadvantageous in that the SEI (solid electrolyte interphase) layer is not stabilized and deterioration easily occurs. The disclosed embodiment may provide a lithium secondary battery having improved durability using an electrolyte including LiDFOB. A detailed description thereof is described later.

The Si-based anode active material includes silicon oxide, silicon particles, silicon alloy particles, and the like. Representative examples of the alloy include a solid solution of aluminum (Al), manganese (Mn), iron (Fe), titanium (Ti), etc. with a silicon element, an intermetallic compound, an eutectic alloy, etc., but the alloys according to an exemplary embodiment of the present invention are not limited thereto.

The anode active material according to the exemplary embodiment may include a composite of a graphite-based anode active material and a silicon (Si)-based anode active material. The silicon-based anode active material may be included in an amount of 5 to 30 wt % based on the total weight of the anode.

A cathode active material which is used to manufacture the cathode according to the exemplary embodiment may include a compound allowing reversible intercalation and deintercalation of lithium. The cathode active material may be at least one type of a composite oxide of lithium and a metal selected from the group consisting of cobalt, manganese, nickel, and a combination thereof.

The electrode according to the exemplary embodiment may further include other additives, such as a dispersion medium, a conductive material, a viscosity modifier, and a filling material, in addition to the electrode active material and the binder described above.

The separator may prevent a short circuit between the cathode and the anode, and provide a passage of lithium ions. The separator may be a polyolefin-based polymer film including polypropylene, polyethylene, polyethylene/polypropylene, polyethylene/polypropylene/polyethylene, and polypropylene/polyethylene/polypropylene or a multilayer film thereof, a microporous film, fabric, and non-woven fabric, which are well-known in the related art. Also, a microporous polyolefin film coated with a resin having high stability may be used for the separator. When the electrolyte is provided using a solid electrolyte such as a polymer, the solid electrolyte may also function as the separator.

The electrolyte may include lithium salt and a non-aqueous organic solvent, and may further include an additive for improving the charging/discharging characteristics and preventing overcharging. The lithium salt may be, for example, a mixture of one or more materials selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N (LiFSI), and (CF₃SO₂)₂NLi.

The non-aqueous organic solvent may be carbonate, ester, ether, or ketone, which may be used alone or in combination. The carbonate may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), fluoroethylene carbonate (FEC), vinylene carbonate (VC), etc., the ester may be γ-butyrolactone (GBL), n-methyl acetate, n-ethyl acetate, n-propyl acetate, etc., and the ether may be dibutyl ether, although not limited thereto.

Also, the non-aqueous organic solvent may further include an aromatic hydrocarbon organic solvent. Examples of the aromatic hydrocarbon organic solvent may be benzene, fluorobenzene, bromobenzene, chlorobenzene, cyclohexylbenzene, isopropyl benzene, n-butylbenzene, octyl benzene, toluene, xylene, mesitylene, etc., which may be used alone or in combination.

Hereinafter, the anode of the lithium secondary battery according to the exemplary embodiment is described in detail. In the following description, the unit is represented by weight % (wt %), unless indicated otherwise.

The anode of the lithium secondary battery according to the disclosed embodiment includes a composite of graphite and a silicon-based material as an electrode active material as described above. The silicon-based material may be contained in an amount of 5 to 30 wt %, preferably 10 to 20 wt %, based on the total weight of the anode.

The electrolyte of the lithium secondary battery according to the disclosed embodiment is prepared by dissolving 1.0M LiPF6 salt and 1 to 10 wt % LiDFOB based on the total weight of the electrolyte in a mixed solvent of ethylene carbonate (EC), ethyl methyl carbonate (EMC) and diethyl carbonate (DEC) in a volume ratio of 20:50:30. LiDFOB may preferably be included in an amount of 5 to 10 wt %.

FIGURE shows a cycle performance profile of an anode according to the disclosed embodiment.

As shown in FIGURE, a capacity retention rate depending on whether LiDFOB is added to the anode including 10% silicon is shown. In the absence of LiDFOB, the capacity retention rate is rapidly reduced by the deterioration of the silicon due to the increase of the lifetime. However, the capacity retention rate is not significantly reduced by the dense SEI layer when 10% LiDFOB is added thereto.

Hereinafter, a method of producing a lithium secondary battery is described, and the results of performance measurement according to the content of the constituent components are described with reference to Table 1.
Cathode: NCM series material as an active material, PVdF as a binder, and plate-like graphite as a conductive material were dispersed in N-Methyl-2-pyrrolidinone (NMP) in a ratio of 95:3:2. The slurry was coated on an Al foil, dried and rolled to prepare a cathode.
Anode: A composite of natural graphite and silicon was prepared as an anode active material.
Electrolyte: An electrolyte was prepared by dissolving 1.0 M LiPF6 salt and LiDFOB in a solvent including EC, EMC, and DEC mixed in a volume ratio of 20:50:30.
Cell Fabrication: A pouch-type lithium ion battery was fabricated using a PE membrane with a thickness of 10 μm and coated with a ceramic.
Evaluation method: A battery having undergone a series of formation/aging processes was charged/discharged at 45° C. to measure the capacity retention rate.
   Charging was performed by CC-CV method at 0.5 C up to 4.2 V and discharging was performed by CC method at 0.5 C up to 2.5 V. A discharge capacity rate after 200 cycles was determined based on a capacity of a first discharge, and the discharge capacity rate was determined based on 100 cycles when durability was terminated earlier than 200 cycles.

TABLE 1

| | | | Capacity | Resistance |
|---|---|---|---|---|
| | Si | LiDFOB | Retention rate | Increase Rate |
| number | (wt %) | (wt %) | (@200 cycle) | (@200 cycle) |
| 1 | 3 | 0 | 85% | 120% |
| 2 | | 5 | 87% | 120% |
| 3 | | 15 | 70% | 200% |
| 4 | 10 | 0 | 80% | 150% |
| 5 | | 5 | 85% | 150% |
| 6 | | 10 | 88% | 160% |
| 7 | | 15 | 83% | 200% |
| 8 | 30 | 0 | 63% | 180% |
| 9 | | 5 | 68% | 170% |
| 10 | | 10 | 72% | 170% |
| 11 | | 20 | 60% | 220% |
| 12 | 50 | 0 | 35% | 300% |
| | | | (@100 cycle) | |
| 13 | | 5 | 33% | 250% |
| | | | (@100 cycle) | |
| 14 | | 20 | 34% | 260% |
| | | | (@100 cycle) | |

Referring to Table 1, it may be seen that the critical characteristics are shown when the Si content is 5 to 30% and the LiDFOB content is 1 to 10% (Examples 5, 6, 9 and 10). When the Si content is 10 to 20% and the LiDFOB content is 5 to 10% (Examples 5 and 6), it may be seen that the life characteristics are the best.

When the Si content is less than 5% (Examples 1, 2 and 3), there is no significant difference in characteristics depending on the LiDFOB content. When LiDFOB is 15% or more (Example 3), lifetime characteristics are interfered by LiDFOB provided as a resistor, and the resistance increase rate is increased.

When the Si content is 10 to 30%, the lifetime characteristics are improved due to formation of a solid SEI layer using 5 to 10% LiDFOB (Examples 5, 6, 9, and 10). However, when the LiDFOB is 15% or more, LiDFOB acts as a resistor to interfere with the lifetime characteristics, decreasing the capacity retention rate.

When the Si content is 30% or more, it may be seen that the lifetime is not improved by the LiDFOB content.

The lithium secondary battery according to the disclosed embodiment utilizes an electrolyte including LiDFOB for stabilizing an anode using a silicon based material, so that a dense SEI layer is formed on the surface of the silicon based material, and durability characteristics are improved.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A lithium secondary battery comprising:
a cathode;
an anode;
a separator disposed between the cathode and anode; and
an electrolyte;
wherein the anode comprises a silicon-based material,
wherein the electrolyte comprises 1 to 10 wt % of LiDFOB based on a total weight of the electrolyte.

2. The lithium secondary battery according to claim 1, wherein the electrolyte comprises 5 to 10 wt % of the LiDFOB based on the total weight of the electrolyte.

3. The lithium secondary battery according to claim 1, wherein the anode comprises 5 to 30 wt % of the silicon-based material based on a total weight of the anode.

4. The lithium secondary battery according to claim 1, wherein the anode comprises 10 to 20 wt % of the silicon-based material based on a total weight of the anode.
